(19) United States
(12) Patent Application Publication
(10) Pub. No.: US 2010/0093903 A1
(43) Pub. Date: Apr. 15, 2010

(54) SPRAYABLE COMPOSITION

(76) Inventors: Gerhard SPIES, Dielheim (DE); Roland Studenroth, Wiesloch (DE); Christian Schmid, Sinsheim (DE); Gunter Perner, Hockenheim (DE)

Correspondence Address: BERENATO & WHITE, LLC, 6550 ROCK SPRING DRIVE, SUITE 240, BETHESDA, MD, 20817, US

(21) Appl. No.: 12/562,215

(22) Filed: Sep. 18, 2009

(30) Foreign Application Priority Data
Sep. 19, 2008 (EP) 08 016 550.9
Apr. 30, 2009 (EP) 09 006 003.9

(51) Int. Cl. C08K 3/34; C08K 5/02; C08K 5/5419

(52) U.S. Cl. 524/261; 524/462; 524/442

(57) ABSTRACT

The invention relates to a sprayable composition containing an aqueous pressure-sensitive adhesive component as well as tetrafluoroethane, nitrogen, carbon dioxide, and/or compressed air. A further subject of the invention is an aerosol container, having a closable spray opening, that contains the composition.

### CROSS-REFERENCE TO RELATED APPLICATIONS AND CLAIM TO PRIORITY

This application is related to application number 08 016 550.9, filed Sep. 19, 2008 with the European Patent Office, and application number 09 006 003.9, filed Apr. 30, 2009 with the European Patent Office, the disclosures of which are incorporated herein by reference and to which priority is claimed.

### FIELD OF THE INVENTION

The invention relates to a sprayable composition, and to an aerosol container that has a closable spray opening and contains the sprayable composition.

### BACKGROUND OF THE INVENTION

Sprayable compositions that can be sprayed out onto a substrate from a suitable apparatus, for example an aerosol container having a spray opening, are known in the existing art. Such compositions contain, in addition to one or more polymeric pressure-sensitive adhesive components, organic solvents and adjuvants such as defoamers and wetting agents. At least one propellant gas is also added. One such sprayable composition is described, for example, in German Application DE-OS 1 904 549.

The organic solvents utilized in the context of the known compositions are objectionable not only from an environmental standpoint but also in terms of health problems. Attempts have therefore been made to replace the polymeric pressure-sensitive adhesive components dissolved in organic solvents with aqueous pressure-sensitive adhesive components. Considerable complications arose here, however, since with the compositions known in the existing art, precipitation of the pressure-sensitive adhesive components occurs in the aerosol container and ultimately leads to clogging of the spray opening.

For these reasons, sprayable compositions having aqueous pressure-sensitive adhesive components are sprayable at present only with the aid of double-chamber aerosol containers, in which the pressure-sensitive adhesive component and the propellant are located separately in different chambers. These containers are technically complex.

### SUMMARY OF THE INVENTION

It is therefore the object of the present invention to describe a sprayable composition that is very largely free of organic solvents and is stable over a long period of time, and in which, in particular, the pressure-sensitive adhesive component does not precipitate during storage.

It has been found, surprisingly, that this object is achieved by a sprayable composition that contains an aqueous pressure-sensitive adhesive component as well as tetrafluoroethane, nitrogen, carbon dioxide, and/or compressed air as a propellant gas. The composition according to the present invention is notable for the fact that it is stable in an aerosol container, i.e. no clogging of the spray opening of the aerosol container occurs even after extended storage. It is thus possible to introduce the composition of the invention without difficulty into conventional single-chamber aerosol containers, and to spray it out of them.

A further advantage of the composition according to the present invention is moreover that its stability with respect to precipitation of pressure-sensitive adhesive components in the aerosol container also ensures a fine and homogeneous spray pattern for the composition according to the present invention on a surface; this has a positive effect on adhesion properties.

The compositions according to the present invention are furthermore notable for the fact that because of their composition they are not flammable, and the composition introduced into corresponding aerosol containers consequently need not be labeled with a hazardous-material symbol of that kind. Leaving aside the objective industrial-safety advantages that proceed from lack of flammability, the absence of a labeling requirement for a product according to the present invention additionally yields a marketing advantage with respect to other products imprinted with hazardous-material symbols.

The use of tetrafluoroethane, or mixtures of tetrafluoroethane with nitrogen, carbon dioxide, and/or compressed air, is particularly preferred. On the one hand, the solvent properties of tetrafluoroethane that are present to a certain extent counteract clogging of the nozzle of an aerosol container by polymer components of the aqueous pressure-sensitive adhesive component.

A further advantage as compared with the other aforesaid propellant gases results from the fact that because of its critical point, tetrafluoroethane can be liquefied relatively easily at room temperature even under slight pressure. Because of these favorable thermodynamic properties, tetrafluoroethane can therefore be present in liquid form in an aerosol can filled with the composition according to the present invention, with the result that a higher propellant gas content is possible without exceeding the permissible can pressure.

A further advantage of the use of tetrafluoroethane as a propellant gas, alone or in combination with the other aforementioned propellant gases, is that a particularly fine spray pattern can be achieved when spraying a composition of this kind out of an aerosol can. One possible explanation for this is that because of the liquid aggregate state of tetrafluoroethane in the aerosol can, it forms a fine, heterogeneous, two-phase system with the aqueous adhesive component when sprayed out. As a result of evaporation of the tetrafluoroethane from this system, and the expansion caused thereby, the individual droplets of the composition in the spray mist are additionally broken apart, thereby explaining the finer spray pattern.

According to a further development of the composition according to the present invention, it contains tetrafluoroethane in the form of 1,1,1,2-tetrafluoroethane and/or 1,1,2,2,-tetrafluoroethane.

The composition can contain 30 to 70, preferably 35 to 65, particularly preferably 37.5 to 62.5, more preferably 45 to 55, and especially preferably 50 wt % tetrafluoroethane.

The pressure-sensitive adhesive component can preferably contain an aqueous dispersion of an acrylic ester copolymer, of an acrylic acid ester-vinyl acetate-ethylene copolymer, and/or of a vinyl acetate-ethylene copolymer. The use of these polymers as a pressure-sensitive adhesive component is particularly advantageous because such polymer dispersions are particularly resistant to precipitation of the pressure-sensitive adhesive components in the aerosol container, especially in the context of use in the composition according to the present invention having tetrafluoroethane.

The composition can contain by preference 10 to 50, preferably 15 to 45, particularly preferably 20 to 40, more preferably 22 to 38, and especially preferably 25 to 35 wt % of the pressure-sensitive adhesive component. All the wt % indications in this Application refer respectively to the entire composition of the composition according to the present invention.

According to a further preferred embodiment the composition can contain, in addition to the water present in the aqueous pressure-sensitive adhesive component, 10 to 50, preferably 12 to 40, particularly preferably 13 to 35, and especially preferably 14 to 25 wt % water. The viscosity of the composition according to the present invention, and thus its applicability by means of an aerosol container, can be adapted in this fashion.

Tackifying resins can be added to the pressure-sensitive adhesive component in order to modify its tack properties. Colophon resins are particularly suitable for this.

According to a preferred embodiment of the invention, the composition can additionally contain defoamers and/or wetting agents. This is particularly advantageous because a composition according to the present invention of this kind, when sprayed by means of an aerosol container, has less tendency to form bubbles and moreover forms a homogeneous adhesive film on the sprayed substrate when even a small amount of the composition according to the present invention is applied.

In particular, one or more defoamers selected from the group encompassing nonionogenic solids, hydrophobic silicic acid, and white mineral oil can be contained in the composition. The proportion of the defoamer or defoamers can be 0.1 to 10, preferably 0.15 to 5, particularly preferably 0.2 to 1, more preferably 0.25 to 0.5, and especially preferably 0.3 to 0.4 wt % defoamer(s).

The wetting agents contained in the composition can be, in particular, siloxane-based wetting agents.

The wetting agents can advantageously constitute 0.1 to 0.6, preferably 0.15 to 0.5, particularly preferably 0.2 to 0.45, and especially preferably 0.3 to 0.4 wt % of the composition.

According a particularly preferred embodiment of the composition according to the present invention, the latter is very largely free of organic solvents that are liquid at 20° C. under standard pressure and have a boiling point of up to 200° C., preferably up to 150° C. This is understood to mean that the composition according to the present invention has a concentration of the above-designated solvents of less than 5 wt %, preferably less than 3 wt %, and very particularly preferably less than 2 wt %. Very particularly preferred compositions according to the present invention are notable for the fact that they comprise only traces of the aforementioned organic solvents. Such compositions exhibit particularly good environmental compatibility, and also represent a definite reduction in health risk for the user. It is moreover possible in this fashion to prevent the solvent odor, perceived in some cases as unpleasant, when spray adhesives of this kind are sprayed, even if no direct health hazard should arise from such solvents.

The invention further relates to an aerosol container, in particular a single-chamber aerosol container, having a closable spray opening, in which container a sprayable composition according to the present invention is contained.

The invention is further explained below in detail, with reference to exemplifying embodiments.

Table 1 indicates the compositions, in percent by weight, of five sprayable compositions according to the present invention. An aqueous dispersion of an acrylic ester copolymer (Acronal V 215), a combination of nonionogenic solids, hydrophobic silicic acids, and aromatic-free medical-grade white mineral oils (Agitan 315) as defoamer, and a polyether-modified polysiloxane (Tego Twin 4000) as a wetting agent, was used for each of the compositions. Compositions A to F were each manufactured in the following manner:

The aqueous dispersion of the acrylic ester copolymer was placed in a stirring vessel, and the combination of the nonionogenic solids, hydrophobic silicic acids, and white mineral oils (Agitan 315) and the polyether-modified polysiloxane was added while stirring. After 10 minutes of stirring, the water was added and stirring continued for a further 10 minutes. The mixture thus produced was then introduced into a suitable aerosol container which was then closed off with a valve. The aerosol container was then filled with the indicated quantity of 1,1,1,2-tetrafluoroethane respectively nitrogen.

TABLE 1

| | A | B | C | D | E | F |
|---|---|---|---|---|---|---|
| Acrylic ester copolymer | 30.0 | 37.5 | 22.3 | 25.0 | 35.0 | 59.2 |
| Water | 19.4 | 24.2 | 13.7 | 24.4 | 14.4 | 38.25 |
| Defoamer | 0.3 | 0.4 | 0.4 | 0.3 | 0.3 | 0.6 |
| Wetting agent | 0.3 | 0.4 | 0.4 | 0.3 | 0.3 | 0.6 |
| 1,1,1,2-Tetrafluoroethane | 50.0 | 37.5 | 62.5 | 50.0 | 50.0 | 0 |
| Nitrogen | 0 | 0 | 0 | 0 | 0 | 1.35 |

The compositions produced were stable, i.e. no precipitation of the acrylic ester copolymer was observed even after extended storage in aerosol containers.

Spray tests were additionally carried out using compositions D, E, and F. In order to determine the spray-out rate, a previously weighed plastic vessel was sprayed with one of the compositions, for 10 seconds in each case, from an aerosol container that contained it. A vortex spray head having a 0.5 mm metering slit and a 0.5 mm nozzle opening was used. The spacing between the vortex spray head and the plastic vessel was 0.1 m. Care was taken, in the context of the determination, to collect the spray contact adhesive component quantitatively. The plastic vessel was then weighed again in order to ascertain the sprayed-on quantity of contact adhesive component. The quality of the spray pattern was also determined by visual inspection. Each spray experiment was repeated three times. The quantitative indications reproduced in Table 2 are in each case the average of the sprayed-on quantities of the pressure-sensitive adhesive component ascertained for the individual spray experiments.

TABLE 2

| | D | E | F |
|---|---|---|---|
| Sprayed quantity (g/10 s) | 6.8 | 7.9 | 14.5 |
| Spray pattern | fine, uniform | fine, uniform | uniform, high |
| | | | spray-out rate |

The spray experiments show that fine, uniform spray patterns can be produced with the compositions according to the present invention. The tetrafluoroethane-containing compositions D and E, in particular, exhibit a particularly fine spray pattern. In addition, no clogging of the spray openings with pressure-sensitive adhesive components already precipitated in the aerosol container was observed during performance of the spray test.

1. A sprayable composition containing an aqueous pressure-sensitive adhesive component as well as tetrafluoroethane, nitrogen, carbon dioxide, and/or compressed air.

2. The composition according to claim 1, wherein the tetrafluoroethane is selected from 1,1,1,2-tetrafluoroethane and/or 1,1,2,2,-tetrafluoroethane.

3. The composition according to claim 1, wherein it contains 30 to 70, in particular 35 to 65 wt % tetrafluoroethane.

4. The composition according to claim 1, wherein the pressure-sensitive adhesive component contains an aqueous dispersion of an acrylic ester copolymer, of an acrylic acid ester-vinyl acetate-ethylene copolymer, and/or of a vinyl acetate-ethylene copolymer.

5. The composition according to claim 1, wherein it contains 10 to 50, in particular 15 to 45 wt % of the pressure-sensitive adhesive component.

6. The composition according to claim 1, wherein it contains, in addition to the water present in the aqueous pressure-sensitive adhesive component, 10 to 50, in particular 12 to 40 wt % water.

7. The composition according to claim 1, wherein the pressure-sensitive adhesive component contains tackifying resins, in particular colophon resins.

8. The composition according to claim 1, wherein it contains defoamers and/or wetting agents.

9. The composition according to claim 8, wherein it contains one or more defoamers selected from the group encompassing nonionogenic solids, hydrophobic silicic acid, and white mineral oil.

10. The composition according to claim 8, wherein it contains 0.1 to 10, in particular 0.15 to 5 wt % defoamer(s).

11. The composition according to claim 8, wherein it contains a siloxane-based wetting agent.

12. The composition according to claim 8, wherein it contains 0.1 to 0.6, in particular 0.15 to 0.5 wt % wetting agent.

13. The composition according to claim 1, wherein it is very largely free of organic solvents that are liquid at 20° C. under standard pressure and have a boiling point of up to 200° C., in particular up to 150° C.

14. The composition according to claim 2, wherein it contains 30 to 70, in particular 35 to 65 wt % tetrafluoroethane.

15. The composition according to claim 9, wherein it contains 0.1 to 10, in particular 0.15 to 5 wt % defoamer(s).

16. The composition according to one of claim 9, wherein it contains a siloxane-based wetting agent.

17. The composition according to one of claim 10, wherein it contains a siloxane-based wetting agent.

18. The composition according to one of claim 9, wherein it contains 0.1 to 0.6, in particular 0.15 to 0.5 wt % wetting agent.

19. The composition according to one of claim 10, wherein it contains 0.1 to 0.6, in particular 0.15 to 0.5 wt % wetting agent.

20. An aerosol container, in particular a single-chamber aerosol container, having a closable spray opening, containing a sprayable composition according to claim 1.
